(19) United States
(12) Patent Application Publication
(10) Pub. No.: US 2012/0075105 A1
(43) Pub. Date: Mar. 29, 2012

(54) INDICATION DEVICE, METHOD FOR PRODUCING INDICATON DEVICE, AND ELECTRONIC DEVICE WITH THE INDICATION DEVICE

(75) Inventor: DA-YI PENG, Tu-Cheng (TW)

(73) Assignee: HON HAI PRECISION INDUSTRY CO., LTD., Tu-Cheng (TW)

(21) Appl. No.: 13/097,086

(22) Filed: Apr. 29, 2011

(30) Foreign Application Priority Data
Sep. 28, 2010 (CN) 201010294979.X

(51) Int. Cl. G08B 21/00

(52) U.S. Cl. 340/636.1

(57) ABSTRACT

An indication device includes a substrate, a printed image, and a backlight source. The substrate is transparent or semi-transparent. The printed image is printed on a surface of the substrate and includes a first sub-image with a first color and a second sub-image with a second color. The backlight source setting on an opposite second surface of the substrate and capable of emit different color light. When the backlight source emits light with color different from both of the first color and the second color, the whole printed image is visible and indicates a first status of the task being executed. When the backlight source emits light with the same color as the second color, only the first sub-image is visible, the printed image indicates a second status of the task being executed.

### BACKGROUND

1. Technical Field

The present disclosure relates to indication device and, particularly, to an indication device providing status of an electronic device and method for producing the indication device.

2. Description of Related Art

Nowadays, electronic devices such as mobile phones have more and more functions and can execute a number of tasks. Usually, when the electronic device executes a task, an indication is shown to indicate a status of the task being executed, and when the status of the executing function is changed, the indication is changed too. For example, when the electronic device executes a communication task, such as transmitting data to another electronic device, an indication indicating the percent of completion of the data transmission is shown, when the data transmission is completed, another indication indicating the completion of the data transmission is shown. Usually, the electronic device employs image displayed on its display to indicate the status of the task being executed, and changes image when the status of the task being executed is changed. However, in order to display the image, the whole display needs to be kept in a working state, which would result in increasing power consumption.

Therefore, it is desirable to provide an indication device to overcome the described limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an indication device, in accordance with an exemplary embodiment.

FIG. 2 is a structure diagram of the indication device of FIG. 1, in accordance with an exemplary embodiment.

FIGS. 3-6 are example diagrams of a printed image of the indication device of FIG. 1.

FIG. 7 is a flowchart illustrating a method for producing an indication device such as, for example, that of FIG. 1, in accordance with an exemplary embodiment.

FIG. 8 is a block diagram of an electronic device with the indication device of FIG. 1, in accordance with an exemplary embodiment.

### DETAILED DESCRIPTION

Embodiments of the present disclosure will now be described in detail, with reference to the accompanying drawings.

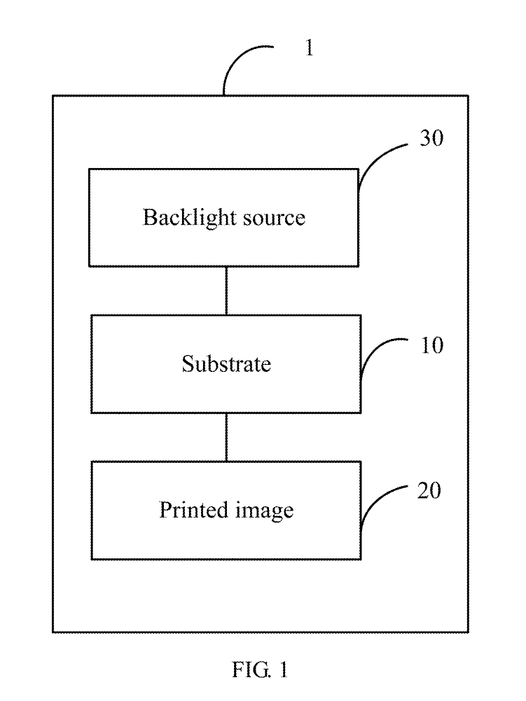

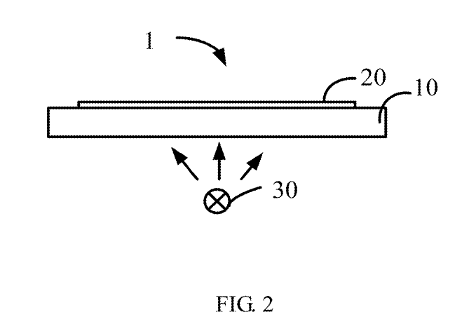

Referring to FIGS. 1-6 together, an indication device 1 for indicating status of an task being executed of an electronic device (not shown) is provided. The indication device 1 includes a substrate 10, at least one printed image 20, and a backlight source 30. The printed image 20 is printed on one surface of the substrate 10, and the backlight source 30 is set on an opposite second surface of the substrate 10. The substrate 10 is transparent or semi-transparent so that the backlight source 30 can emit light to illuminate the printed image 20 via the substrate 10. The backlight source 30 is configured to emit light of a different color when the status of the task being executed is changed, and the display of the printed image 20 is changed with the color change of the light emitted from the backlight source 30, to indicate different statuses of the task being executed.

In the embodiment, the substrate 10 is transparent or semi-transparent and can be made of glass or plastic. The printed image 20 is used for indicating status of a task, such as data transmission task, power charge task, etc. The printed image 20 can be a film pasted on the substrate 10 or can be etched on the substrate 10 directly. In the embodiment, the printed image 20 includes a first sub-image P1 with a first color and a second sub-image P2 with a second color different from the first color. In the embodiment, the task being executed with at least two status, and can change from a first status to a second status, the printed image indicates a first status of the task being executed when the whole printed image 20 is visible, and indicates a second status of the task being executed when only the first sub-image P1 is visible.

In the embodiment, the backlight source 30 is a light emitted diode (LED) unit, which includes at least one LED, when the current flowing through the backlight source 30 is changed, the color of the light emitted by the backlight source 30 is changed too.

It is well known, that a semi-transparent image with a color is placed on a surface with the same color, the image would be invisible. In the embodiment, the whole printed image 20 is visible and indicates the first status of the task being executed, when the backlight source 30 emits light with a color different form the first color of the first sub-image P1 and the second color of the second sub-image P2; the first sub-image P1 is visible and the second sub-image P2 is invisible and indicates the second status of the task being executed, when the color of the light emitted by the backlight source is the same as the second color of the second sub-image P2. In another embodiment, when only the second sub-image P2 is visible, the printed image 20 indicates a third status of the task being executed.

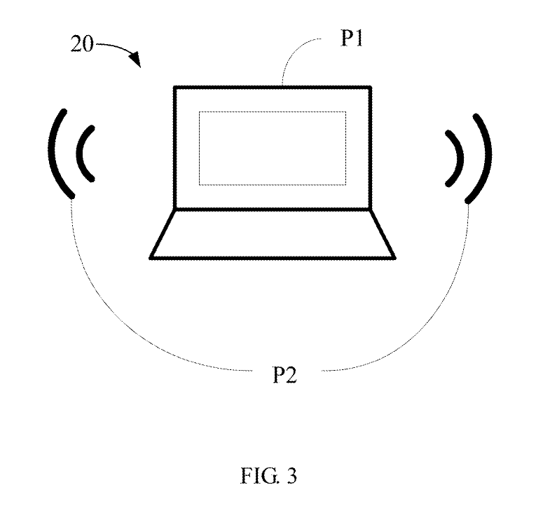

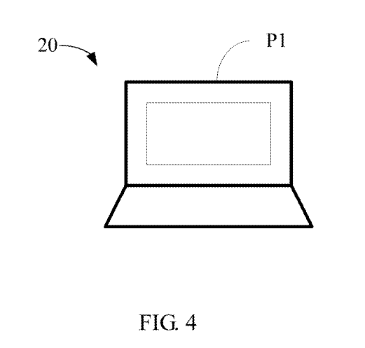

In a first embodiment as that shown in FIGS. 3-4, the printed image 20 is configured for indicating a status of a data transmission task. For example, as shown in FIG. 3, in the embodiment, the first color of the first sub-image P1 is green color and the second color of the second sub-image P2 is yellow color, when the backlight source 30 emits light with color different from that of the first sub-image P1 and the second sub-image P2, such as blue color, the whole printed image 20 is visible and accordingly a status of transmitting data is indicated. As shown in FIG. 4, when the backlight source 30 emits yellow colored light, only the first sub-image P1 is visible, and accordingly, a status of data transmission completion is indicated

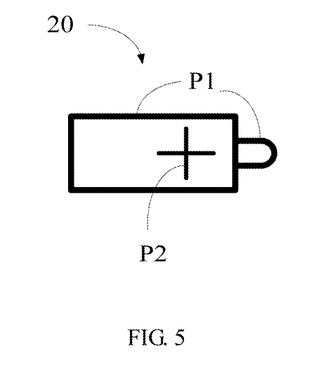

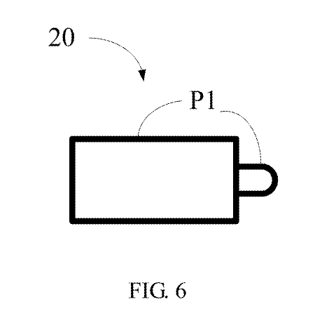

In another embodiment as that shown in FIGS. 5-6, the printed image 20 is configured for indicating a status of a power charge task. For example, as shown in FIG. 5, in the embodiment, the color of the first sub-image P1 is green color and the color of the second sub-image P2 is yellow color. When the whole printed image 10 is visible, a status of being charging is indicated; when only the first sub-image P1 is visible, a status of charging completion is indicated.

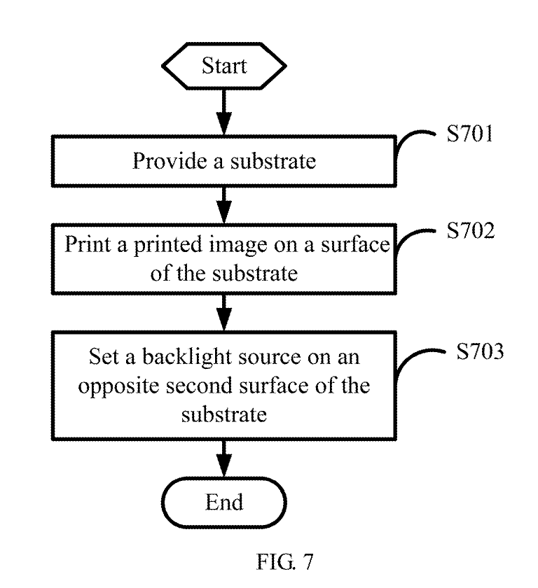

FIG. 7 shows a method for producing an indication device such as, for example, that of FIG. 1. In step S701, a transparent or semi-transparent substrate 10, which can be made of glass or plastic, is provided.

In step S702, a printed image 20 is printed on a surface of the substrate 10. In the embodiment, the printed image 20 can be a film which is pasted on the surface of the substrate 10, in another embodiment, the printed image 20 can be etched on the surface of the substrate 10 directly.

In step S703, a backlight source 30 is set on the opposite second surface of the substrate 10.

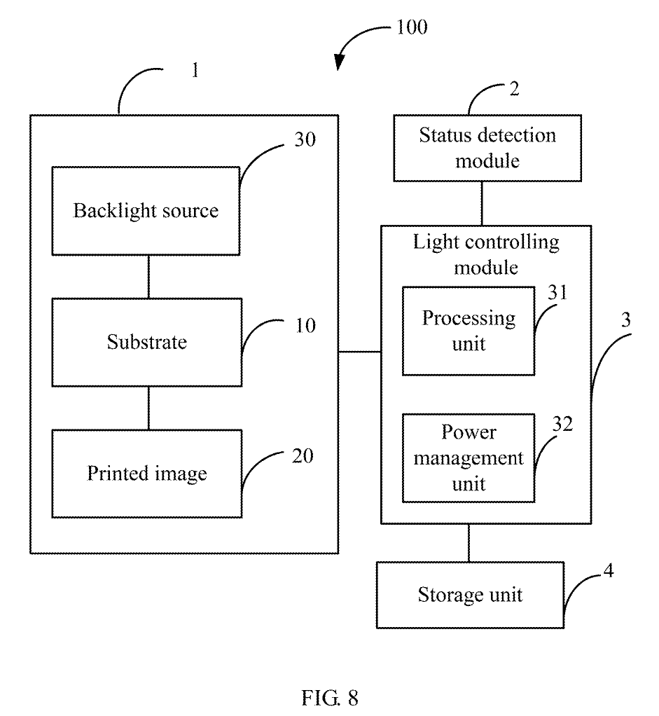

Referring to FIG. 8, an electronic device 100 including at least one indication device 1 as shown in FIG. 1 is provided. The electronic device 100 further includes a status detection module 2 and a light controlling module 3. The electronic device 100 can execute at least one task, and the indication device 1 is used for indicating the status of the task which is being executed by the electronic device 100.

The state detection module 2 is used to detect a current status of the task being executed. The light controlling module 3 is used to control the backlight source 30 to emit light with corresponding color according to a detection result from the state detection module 2. For example, when the status detection module 2 detects the task being executed is at the first status, the light controlling module 3 controls the backlight source 30 to emit light with color different from both of the first sub-image P1 and the second sub-image P2, accordingly, the whole printed image 20 is visible and the first state of the task being executed is indicated. When the status detection module 2 detects the task being executed is at the second status, the light controlling module 3 controls the backlight source 30 to emit light with the same color as the second sub-image P2, accordingly, only the first sub-image P1 is visible and the second state of the task being executed is indicated.

As described above, the backlight source 30 emits light with a predetermined color according to a current with a predetermined value through it. The electronic device further includes a storage unit 40 storing a relationship table recording relationships between light color and current value.

In the embodiment, the status detection module 2 can be a microcontroller. The light controlling module 3 includes a processing unit 31 and a power management unit 32. When the status detection module 2 detects the status of the task being executed is at the first status, the processing unit 31 controls the power management unit 32 to provide a first voltage to produce a corresponding current through the backlight source 30. In addition, the backlight source 30 emits light with color different that of the first sub-image P1 and the second sub-image P2. Therefore, the complete printed image 20 is visible and indicates the first status of the task being executed.

When the status detection module 2 detects the status of the task being executed is at the second status, the processing unit 31 controls the power management unit 32 to provide a second voltage to produce a corresponding current through the backlight source 30, and the backlight source 30 emits light with the same color as that of the second sub-image P2. Therefore, only the first sub-image P1 is visible, the printed image 20 indicates the second status of the task being executed.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An indication device for indicating status of a task being executed of an electronic device, the indication device comprising:
a substrate, which is transparent or semi-transparent;
a printed image printed on a surface of the substrate, the printed image comprising a first sub-image with a first color and a second sub-image with a second color; and
a backlight source setting on an opposite second surface of the substrate and capable of emit light of different colors;
wherein, when the backlight source emits light with a color different from the first color of the first sub-image and the second color of the second sub-image, the whole printed image is visible and indicates a first status of the task being executed, when the backlight source emits light of the same color as the second color of the second sub-image, only the first sub-image is visible, the printed image indicates a second status of the task being executed.

2. The indication device according to claim 1, wherein the printed image can be a film pasted on the substrate or can be etched on the substrate directly.

3. The indication device according to claim 1, wherein the backlight source is a light emitted diode (LED) unit, which includes at least one LED, when the current flowing through the backlight source is changed, the color of the light emitted by the backlight source is changed too.

4. The indication device according to claim 1, wherein the substrate is made of glass or plastic.

5. The indication device according to claim 1, wherein when the backlight source emits light with the same color as the first color of the first sub-image, only the second sub-image is visible, the printed image indicates a third status of the task being executed.

6. A method for producing an indication device, the method comprising:
providing a substrate that is transparent or semi-transparent;
printing an printed image on a surface of the substrate, the printed image comprises a first sub-image with a first color and a second sub-image with a second color;
setting a backlight source capable of emitting different color light on opposite second surface of the substrate.

7. An electronic device, comprising:
An indication device, comprising:
a substrate, which is transparent or semi-transparent;
a printed image printed on a surface of the substrate, the printed image comprising a first sub-image with a first color and a second sub-image with a second color; and
a backlight source setting on an opposite second surface of the substrate and capable of emit light of different colors;
a status detection module, configured for detecting current status of a task of the electronic device being executed; and
a light controlling module, configured for controlling the backlight source to emit light with corresponding color according to the status of the task being executed detected by the status detection module;
wherein, when the backlight source emits light with color different from the first color of the first sub-image and the second color of the second sub-image, the whole printed image is visible and indicates a first status of the task being executed, when the backlight source emits light with the same color as the second color of the second sub-image, only the first sub-image is visible, the printed image indicates a second status of the task being executed.

8. The electronic device according to claim 7, wherein the printed image can be a film pasted on the substrate or can be etched on the substrate directly.

9. The electronic device according to claim 7, wherein the backlight source is a light emitted diode (LED) unit, which includes at least one LED, when the current flowing through the backlight source is changed, the color of the light emitted by the backlight source is changed too.

10. The electronic device according to claim 9, wherein the light controlling module includes a processing unit and a power management unit, the processing unit controls the power management unit to provide a corresponding voltage to the backlight source and produce a corresponding current through the backlight source according to status of the task being executed detected by the status detection module.

11. The electronic device according to claim 9, wherein the electronic device further comprises a storage unit storing a relationship table defining relationships between color and value of current flowing through the backlight source.
